(19) United States
(12) Patent Application Publication
(10) Pub. No.: US 2013/0178204 A1
(43) Pub. Date: Jul. 11, 2013

(54) Method of Determining a Radio Link Failure Associated with a Handover of a User Equipment for a Source Access Node to a Target Access Node, Access Node for Determining a Radio Link Failure Associated with a Handover of a User Equipment from a Source Access Node to a Target Access Node, and User Equipment

(71) Applicants: Yi Zhang, Beijing (CN); Weihua Zhou, Beijing (CN); Richard Waldhauser, Munchen (DE)

(72) Inventors: Yi Zhang, Beijing (CN); Weihua Zhou, Beijing (CN); Richard Waldhauser, Munchen (DE)

(73) Assignee: Nokia Siemens Networks OY, Espoo (FI)

(21) Appl. No.: 13/643,607

(22) PCT Filed: Aug. 13, 2010
(86) PCT No.: PCT/CN10/01225

§ 371 Date: Mar. 25, 2013

(30) Foreign Application Priority Data
Apr. 27, 2010 (CN) 2010/000575
Apr. 30, 2010 (CN) 2010/000596

(51) Int. Cl. H04W 24/02

(52) U.S. Cl. CPC H04W 24/02
USPC 455/423

(57) ABSTRACT

A method of determining a radio link failure associated with a handover of a user equipment from a source access node to a target access node includes acquiring a first information about a time associated with the user equipment communicating with an access node for establishing a connection associated with the handover and a second information indicating the access node with which the user equipment communicates for establishing a connection subsequent to the radio link failure, and determining the radio link failure based on the acquired first and/or second information.

### FIELD OF INVENTION

The present invention relates to a method of determining a radio link failure associated with a handover of a user equipment from a source access node to a target access node.

Further, the invention relates to an access node for determining a radio link failure associated with a handover of a user equipment from a source access node to a target access node.

Further, the invention relates to a user equipment.

### ART BACKGROUND

A handover of a user equipment from a source access node of a cell of an access network to a target access node of another cell of the same or another access network may be triggered by the user equipment moving to the another cell to reattach to the target access node residing in this another cell.

During or subsequent to a handover procedure, radio link failures (RLFs) may occur leading to a degradation of an access network performance, since access network resources may be inefficiently used during negotiating the handover procedure between the involved access nodes and the user equipment. Further, handover failures may also negatively impact a user experience.

As known from 3GPP Technical Specification 36.902 V9.0.0, such RLFs may comprise failures due to a too late handover triggering (“too late handover”), failures due to too early handover triggering (“too early handover”) and failures due to a handover to a wrong cell (“handover to wrong cell”).

Further, a non-optimal configuration of handover parameters, even not resulting in such RLFs, may lead to a significant degradation of the service performance of the access network. For instance, an incorrect setting of the handover hysteresis may lead either to a ping-pong effect upon negotiating the handover or to a prolonged connection to a non-optimal cell of the access network.

Further, a missing alignment of cell-reselection parameters to handover parameters may result in unwanted handovers subsequent to a connection setup.

As is known for a long term evolution (LTE) access network, a mobility robustness optimization (MRO) function of a self-optimizing network (SON) function residing within the access nodes of the LTE access network may be used for reducing the impact of handover triggered RLFs on the access network performance. In particular, the MRO function may be used for adapting network parameter settings storable and/or usable by the involved access nodes based on an analysis of the kind of RLF and thus for minimizing the occurrence of such RLFs.

Such a LTE network performance optimization will be described with respect to FIG. 1 in case of a too early handover. A respective communications architecture comprises a user equipment, e.g. a mobile phone 10, a source access node, an eNodeB 12, a target access node, a eNodeB 14, and an another access node, an eNodeB 16, of the LTE access network.

The RLF may occur short time subsequent to the user equipment 10 having successfully attached to the target access node 14. The user equipment 10 then attempts to re-establish a connection to the source access node 12 using the Radio Resource Control (RCC) Connection Reestablishment procedure.

After successfully reconnecting to the source access node 12, the user equipment 10 may enter a so called “connected state”, and the user equipment 10 may send a RLF report to the source access node 12 which in turn sends a RLF indication to the target access node 14.

Subsequent analysis of the kind of handover failure based on the RLF indication executed by the target access node 14 may then offer a possibility to adjust handover parameter settings in the target access node 14 and/or the source access node 12, in order to improve the access network performance in terms of preventing future RLFs.

The performed analysis of the kind of handover related RLF may be based on a determination logic using a first information about a time associated with the accomplishment of the handover, namely a timer called “TStore_UE_Cntxt”, which may be set by the target access node 14 upon notifying the source access node 12 about the accomplishment of the handover, and a second information about the access node from which the RLF indication may have been sent to the target access node 14. The first and second information may be subsequently used in the determination of the RLF. In a first determination it may be evaluated whether the timer has expired or not, whereby distinguishing between a “too late handover” and a “too early handover” or a “handover to a wrong cell” may be achieved, respectively. A second determination may differ between failures due to “a too early handover” and a “handover to wrong cell” by evaluating whether the RLF indication may be received from the source access node 12 of the previously successfully terminated handover procedure or from another access node. The following table summarizes the described mobility robustness optimization determination procedure.

| | RLF indication from | RLF indication from |
|---|---|---|
| TStore_UE_Cntxt | access node 12 | access node 16 |
| Expired | Too late handover | Too late handover |
| Not expired | Too early handover | Handover to wrong cell |

However, the user equipment 10 may not succeed in reconnecting to the access network subsequent to the RLF, since e.g. the target access node 14 may not have obtained respective parameter settings such as a context associated with the user equipment 10 to be reattached. Further, fetching the context of the user equipment 10 may not be supported.

Assuming the user equipment 10 may not succeed in (re-)establishing a connection to the source access node 12, the user equipment 10 may go to a so called “idle state”, and, some time later, may initiate a new attachment procedure to the access network via either the source access node 12 or another access node 16. Signalling based on these two connection possibilities are indicated in FIG. 1 by means of continuous and dotted lines, respectively.

Subsequent to successfully reconnecting to the access network via the another access nodes 10, 16 using a RRCConnection procedure, the RLF indication will be transmitted to the target access node 14 for determining the kind of RLF. Using the above described determination steps may result in a wrong judgement of the kind of RLF in the particular case of the “too early handover” RLF, since, firstly, the used timer may eventually have expired due to the user equipment 10 having gone through the idle state and, secondly, the user equipment 10 may reconnect to the another access node 16 but not to the source access node 12. The following table summarizes respective results of the mobility robustness optimization evaluation of the kind of the RLF.

| | RLF indication from | RLF indication from |
|---|---|---|
| TStore_UE_Cntxt | access node 12 | access node 16 |
| Expired | Too late handover | Too late handover |
| | -> wrong result | -> wrong result |
| Not expired | Too early handover | Handover to wrong cell |
| | -> correct result | -> wrong result |

Thus, improving an access network performance based on the above described determination of the kind of RLF may be poor when a user equipment may go into an idle state subsequent to the RLF.

### SUMMARY OF THE INVENTION

It may be an object of the invention to provide an improved performance of an access network.

In order to achieve the object defined above, a method of determining a radio link failure (RLF) associated with a handover of a user equipment from a source access node to a target access node, an access node for determining a RLF associated with a handover of a user equipment from a source access node to the target access node and a user equipment may be provided.

According to an exemplary aspect of the invention, a method of determining a RLF associated with a handover of a user equipment from a source access node to a target access node may be provided, wherein the method may comprise acquiring a first information about a time associated with the handover and a second information indicating an access node with which the user equipment may communicate for establishing a connection subsequent to the RLF, and determining the RLF based on the acquired first and/or second information.

According to another exemplary aspect of the invention, an access node for determining a RLF associated with a handover of a user equipment from a source access node to a target access node may be provided, wherein the access node may comprise an acquiring unit adapted for acquiring a first information about a time associated with the handover and a second information indicating an access node with which the user equipment may communicate for establishing a connection subsequent to the RLF and a determining unit adapted for determining the RLF based on the acquired first and/or second information.

According to another exemplary aspect of the invention, a user equipment may be provided, wherein the user equipment may be adapted for performing a handover from a source access node to a target access node, wherein the user equipment may comprise a recording unit adapted for recording a first information about a time associated with the handover, and a sending unit adapted for sending the first information and a second information indicating an access node with which the user equipment may communicate for establishing a connection subsequent to the RLF, such that the RLF may be determinable based on the sent first and/or second information.

In the context of the present application, the term “radio link failure” may particularly denote a handover related RLF such as a “too early handover”, a “too late handover” and a “handover to a wrong cell”, as may be specified by the 3GPP Technical Specification 36.902 V9.0.0. In particular, a too late handover may also comprise a RLF which may occur due to a missing handover.

In particular, the source or serving access node and the target access node involved in the handover of the user equipment may be access nodes of the same access network or may be access nodes of different access networks. The handover may be an inter handover between different access networks or an intra handover between access nodes within the same access network.

The term “information about a time” may particularly denote a time value e.g. associated with a time point or a time difference between two time points. In particular, the term may not denote a timer which may start at a particular time point and may expire at a later time point, wherein no accurate time information about e.g. an occurrence of an event or e.g. a time difference between two time points may be deduced.

The term “information about a time associated with the handover” may particularly denote a time associated with an occurrence of the radio link failure or a time associated with the user equipment communicating with an access node for establishing a connection associated with the handover.

Here, the term “communicating with an access node for establishing a connection associated with the handover” may particularly denote a communication with the source access node or the target access node involved in the handover, particularly a communication with these access nodes related to (an indication of) an accomplishment of the handover. The term may also denote a communication with an access node for establishing a connection subsequent to the radio link failure as may be explained in the following.

The term “communicating with an access node for establishing a connection subsequent to the RLF” may particularly denote a (particularly first) initiation of an establishment or set up procedure of a connection to an access node subsequent to the occurrence of the RLF of the (particularly last) handover. In particular, the initiation of the establishment of the connection may be successful or unsuccessful. In particular, the initiation of the establishment of the connection may be immediately subsequent to the occurrence of the radio link failure or timely spaced depending on whether the user equipment may enter (particularly for a short time) an idle state subsequent to the RLF or may remain in a connected state subsequent to the RLF. Here, an “idle state” of an user equipment may particularly denote a state in which the user equipment may not actively communicate with a network as being not attached thereto. However, if a duration of this idle state may be short, the user equipment may maintain information about the access node to which the user equipment has been connected before the occurrence of the RLF. In contrast, a “connect(ed) state” may refer to a state in which a user equipment may be attached to a network and may participate in signalling and media transport.

In particular, the state in which the user equipment may remain or enter subsequent to the RLF may depend on whether a Access Stratum (AS) security function, as may be known for a long term evolution (LTE) access network, may be active or not. In particular, if the AS security function of the user equipment may be active, the user equipment may remain in a connected state and may initiate an establishment procedure of a connection to an access node. If the AS security function of the user equipment may not be active, the user equipment may enter an idle state and may later on, after having detected a suitable cell, initiate an establishment procedure of a connection to an access node and enter a connected state again.

The access node being contacted by the user equipment immediately subsequent to the RLF may depend on the kind of occurred RLF. In particular, in case of a “too late handover”, this access node may be the target access node or another access node but not the source access node, while in case of a “too early handover” this access node may be the source access node. In case of a “handover to a wrong cell” the access node being contacted by the user equipment for establishing a connection subsequent to the RLF may be an another access node but neither the source access node nor target access node.

The access node being contacted by the user equipment timely spaced subsequent to the RLF may be an access node involved in the handover or a further access node.

The second information indicating an access node with which the user equipment may communicate for establishing a connection subsequent to the radio link failure may particularly denote (particularly in case of an unsuccessful establishment of a connection subsequent to the RLF) a value, e.g. a flag, comprised in a message, particularly in a RLF indication message. Further, the second information may also denote (particularly in case of a successful establishment of a connection subsequent to the radio link failure) information derivable by the access node executing the determination of the RLF which information may indicate from which access node the first information and/or an RLF indication message may be received. The second information may then not be comprised in a message, particularly in the RLF indication message.

The term “determining the radio link failure” may particularly denote a determination, e.g. an evaluation or analysis, of particularly the kind or sort of and/or the reason or the root cause of the (handover related) radio link failure. Further, the term may also denote a differentiation of handover related radio link failures from further radio link failures not related to a handover.

According to exemplary aspects of the invention, a RLF may occur before, during or subsequent to a handover procedure of a user equipment from a source or serving access node to a target access node. Thereupon the user equipment may attempt to establish a connection to an access node subsequent to the handover, particularly using a Radio Resource Control (RRC) Reestablishment Connection procedure or a RRC Connection procedure as may be known for a LTE access network. To this end, the user equipment may communicate with an access node for establishing, particularly re-establishing, a connection to an access node.

The determination of the RLF may be based on either the first information or the second information or on both the first and second information with a sequence of determinations being interchangable. In particular, a determination may be interrupted subsequent to executing one of the determinations based on the first and second information.

A determination of the kind or sort of or the root cause of the occurred RLF may be based on first information and/or second information instead of, as previously described, the expirable timer “TStore_UE_Cntxt” and information indicating which access node may have sent the RLF indication for evaluating the RLF. The first information used during the determination of the RLF may relate to fixed and not alterable time information related to an accomplishment of the handover and/or to an occurrence of the RLF and/or to the subsequent attempt of the user equipment to establish a connection to the access network. Thus time delays between the user equipment anew connecting to the access network after having unsuccessfully connected to an access node and having gone to an idle state for a longer time may not falsify the determination of the RLF. The second information indicating the access node with which the user equipment may communicate for establishing a connection to the access network subsequent to the RLF may directly relate to the kind or root cause of radio link failure, as the attempt to connect to the access network may depend of the kind or root cause of radio link failure. In particular, a case in which a user equipment being in idle state for a longer time may anew establish a connection to another access node but not the access node with which a connection usually would have been established based on the kind or root cause of the RLF may also not negatively impact the determination. Thus, the RLF analysis based on the first and/or second information or the combined first and second information may be accurate and lead to appropriate results, since any changes in the communications architecture occurring subsequent to the RLF may not affect the determination of the RLF.

Further, the determination of the radio link failure may be applicable in a case in which the user equipment successfully establishes a connection to an access node subsequent to the occurrence of the radio link failure (and thus may be in a connected state subsequent to a RLF) and in a case in which the user equipment may unsuccessfully attempt to initiate a set up of a connection to an access node subsequent to the occurrence of the radio link failure (and thus may be in an idle state). Thus, compared to prior art, a further and significantly improved possibility of determining a radio link failure may be provided.

Accordingly, a network performance, in particular a performance of a mobility robustness optimization MRO (function) of a self optimizing network SON function residing within access nodes may be significantly enhanced, since an usage of network resources or capacities may be improved in terms of preventing a number of future handover related RLFs due to unnecessary or missed handovers and unwanted handovers subsequent to a connection setup.

Next, further exemplary embodiments of the above mentioned method will be explained. However, these embodiments also apply to the above mentioned access node and to the above mentioned user equipment.

In particular, the first and second information may be acquired simultaneously or subsequently to one another in an arbitrary order.

The second information may comprise a Physical Cell Identifier (PCI) or E-UTRAN Cell Global Identifier (ECGI) of the access node with which the user equipment may communicate for establishing the connection subsequent of the RLF.

In particular, determining the (root cause of the) RLF may be executed by the target access node involved in the handover in case of a too early handover or a handover to a wrong cell. The target access node may acquire, particularly receive (part of) the first information and second information.

In particular, determining the (root cause of the) RLF may be executed by the source access node involved in the handover in case of a too late handover. The source access node may acquire particularly receive, (part of) the first and second information.

The method may further comprise adapting network parameters based on the determined RLF, whereby knowledge of the kind or root cause of the RLF may be used for improving, particularly optimizing, a network performance. In particular, adapting network parameters may comprise the target access node and/or the source access node adapting or adjusting handover related parameters usable and/or storable in the target access node and/or the source access node. In particular, the access node executing the determination may be adapted for sending information about the determined (reason of the) RLF to the further access nodes associated with the handover particularly using a HandoverReport procedure, such that these access nodes may be capable of adapting handover related parameters usable and/or storable by them.

The first information may comprise at least one of a first time point associated with an accomplishment of the handover, a second time point associated with the user equipment communicating with the access node for establishing a connection subsequent to the RLF, and a third time point associated with an occurrence of the radio link failure. The first time point may provide a closest approximation of a point in time of a (successful) handover. The second time point may provide a closest approximation of a point in time of a (successful or unsuccessful) establishment of a connection subsequent to the RLF. The third time point may provide a closest approximation of a point in time of an occurrence of the RLF. Therefore the first time point may refer to a time point prior to the second and third time point when following a time evolution, while the third time point may refer to a time point prior to the second time point. Using one time point, two time points or three time points instead of an expirable timer may provide accurate and absolute time information on the occurrence of the handover and/or the RLF. Using two or three time points instead of one time point may enhance the accuracy of the determination of the RLF, since additional information may be used for determining the RLF. Using only one time point may allow for a more efficient transfer of the necessary information for determining the RLF, since less network capacity may have to be used for transferring the necessary information.

The first information may comprise at least one of a time difference between a first time point associated with an accomplishment of the handover and a second time point associated with the user equipment communicating with the access node for establishing a connection subsequent to the RLF, and a time difference between the first time point associated with an accomplishment of the handover and a third time point associated with an occurrence of the radio link failure, and a time difference between the second time point associated with the user equipment communicating with the access node for establishing a connection subsequent to the RLF and the third time point associated with an occurrence of the radio link failure. The time difference may be a difference between the first time point and the second or third time point or a difference between the second or third time point and the first time point, or a difference between the second time point and the third time point, or a difference between the third time point and the second time point. The time differences mentioned above may be used at the same time. Thus, using relative time information instead of absolute time information as described above may save network resources upon acquiring, particularly transferring or communicating, the first information, since less network capacitance may be necessary for transferring the first information.

Acquiring may comprise the step of determining whether the first time point may be defined. In particular, the term “determining whether the first time point may be defined” may denote a determining whether a measureable or meaningful value can be associated with the first time point. In particular, a not defined time point may comprise or may be a default value. For example, such a meaningful value may correspond to the starting time or ending time of the accomplishment of the handover while a non defined value may correspond to a circumstance where the handover did not start at all. Thus, a further determination may be provided in addition to the determination based on the first and/or second information through which determinations the kind of RLF may be distinguished from one another. In particular, if the first time point may be not defined, e.g. no value could be or was measured, then the RLF may be related to too late handover, whereas an evaluation that the first time point may be defined may result in a too early handover or a handover to a wrong cell. In particular, if determining whether the first time point may be defined, may be executed prior to the determination based on the first and/or the second information, the method may interrupt subsequent to this determination particularly in a case of a too late handover, since no accomplishment of a handover may occur.

In particular, the term “determining whether a first time point may be defined” may also denote a determining whether the time difference between the first time point and the second time point and/or the time difference between the first time point and the third time point and/or the time difference between the second time point and the third time point may be defined and e.g. a measurable or meaningful value can be associated with the time difference(s). In particular, a not defined time difference may comprise a default value. In particular, a further determination may be provided in addition to the determination based on the first and/or second information through which determinations the kind of RLF may be distinguished from one another. In particular, if one of the time differences or both time differences may be not defined, then the RLF may be related to too late handover, whereas an evaluation that one of the time differences or both of the time differences may be defined may result in a too early handover or a handover to a wrong cell.

In particular, determining whether the first time point may be defined and determining whether the time difference(s) may be defined may be both executed subsequent to one another with a sequence order being interchangeable.

In particular, determining whether the first time point may be defined may comprise determining whether the first time point and/or the time difference(s) may be defined by the access node executing the determination of the RLF, particularly whether the first time point may be recorded or stored by the access node executing the determination and/or whether the time difference(s) may be received by the access node executing the determination of the RLF by means of e.g. a message.

The first time point may be associated with the user equipment indicating to the target access node the accomplishment of the handover or with the target access node indicating to the source access node the accomplishment of the handover. The term “accomplishment” of the handover may particularly denote a successful or unsuccessful completion of the handover seen from the perspective of the involved communications partners. The first option may relate to the time point when the user equipment may store or record the time of sending a handover completion indication to the target access node or to the target access node receiving the respective indication. Such an indication may be a RRCConnectionReconfigurationComplete indication. Both time points may be timely almost equivalent as an only very short time difference may be noticeable between these two time points. The second option may relate to the time point when the target access node may store or record a sending of a handover completion indication to the source access node for notifying a release of the connection or to the source access node receiving the respective indication. This notification may be accomplished using a “Release User Equipment Context” message. Again, these two time points are unnoticeable different to one another.

The second time point may be associated with the user equipment indicating to an access node the initiation of a connection (re-)establishment request particularly using a RRCConnectionReestablishmentRequest or RRCConnectionRequest indication or to the access node receiving such an indication. The second time point may also be associated with the access node indicating to the user equipment the reject or acceptance of such a request particularly using RRCConnectionReestablishmentReject or RRCConnectionReestablishmentAccept and RRCConnectionReject or RRCConnectionAccept indications or to the user equipment receiving such an indication.

The third time point may be associated with the occurrence of the radio link failure as may be recorded by the user equipment or by the access node executing the determination of the RLF.

Acquiring may comprise the step of recording at least one of the first time point and the third time point by the user equipment or by the access node executing the determination of the RLF and/or recording the second time point by the user equipment or by the access node with which the user equipment may communicate for establishing the connection subsequent to the RLF. These measures represent easy and accurate possibilities of determining the first and the second time points. Recording the first and second and/or third time points by the user equipment may offer the possibility for the user equipment to determine the time difference between the first and second and/or third time points, and/or the time difference between the second time point and the third time point in order to provide the relative time information. Recording the first and/or second and/or third time points by access nodes may offer accurate and fixed time information of the access network compared to time information which may be provided by the user equipment and may be thus changeable by the user equipment. Recording the first time point by the access node executing the determination of the RLF may be advantageous in connection with acquiring, particularly transferring, the first information comprising only the second and/or third time points, since the access node executing the determination may be provided with all necessary time points while no additional network capacity consuming acquiring, particularly transferring, the information may be required for an additional transfer the first time point.

Determining the RLF may comprise the step of comparing the first information with a predetermined time corresponding to a maximum time difference between a time point associated with the accomplishment of the handover and a time point associated with the user equipment communicating with the access node for establishing the connection subsequent to the RLF. As the RLF occurs within short time subsequent to the accomplishment of the handover, the predetermined time threshold may be used to identify the kind or root cause of the RLF. In particular, if the (absolute value of) the time difference between the first and second time points and/or the time difference between the first and third time points may be less than the predetermined time threshold, determining the RLF may result in identifying the RLF as a too early handover or a handover to a wrong cell. Accordingly, determining that the time difference between the first and second time points and/or the time difference between the first and third time points may be greater than the predetermined time threshold may result in determining that the RLF is due to a too late handover. Thus, an evaluation of the kind of RLF may be provided.

Determining the RLF may comprise the step of determining whether the access node indicated by the second information may be the source access node of the handover. Thus, another possibility for analyzing the kind or root cause of the RLF is provided, whereby the accuracy of the determination of the RLF may be enhanced when applying sequential determination steps. In particular, using this determination may differ between RLFs due to a too early handover and a handover to a wrong cell. In particular, if the access node indicated by the second information may be equivalent to the source access node, determining the RLF may then result in determining that the RLF is a RLF due to a too early handover. Accordingly, if the access node indicated by the second information may not be identical to the source access node, the determined RLF may then be identified as a handover to a wrong cell. In particular, if the determination based on the second information may be executed prior to the determination based on the first information and/or the determination whether the first time point may be defined, the determination based on the second information may accordingly offer a possibility to distinguish between on the one hand a too early handover and a too late handover or on the other hand a handover to a wrong cell and a too late handover.

In particular, information about the source access node with which the second information may be compared may be stored in (particularly a context stored in) the access node executing the determination of the RLF.

The method may comprise acquiring a third information indicating a state from which the user equipment may communicate for establishing a connection to an access node prior to the radio link failure, wherein determining the radio link failure may be based on the third information, and wherein determining the radio link failure may comprise the step of determining whether the state of the user equipment indicated by the third information may be a connected state. In particular, the third information may indicate whether the user equipment may enter a cell from an idle state or a connected state to which the user equipment may have been connected when the RLF occurred. Thus, a differentiation between a handover related radio link failure, particularly a handover to wrong cell, from other radio link failures, particularly a radio link failure associated with the user equipment may camp in a wrong cell prior to the radio link failure and particularly being in an idle state (“Camping in wrong cell”) may be possible. In particular, if the state of the user equipment indicated by the third information may be equivalent to a connected state, determining the RLF may then result in determining that the RLF is a RLF due to a handover to a wrong cell. Accordingly, if the state of the user equipment indicated by the third information may be an idle state, the determined RLF may then be identified as camping in wrong cell. In particular, the sequence of the determinations based on the first and/or second and third information may be interchangeable.

In particular, the third information may be recorded by the user equipment particularly at a time point of the occurrence of the RLF, particularly at the third time point, or particularly at a time point when the user equipment may detect the occurrence of the radio link failure.

Acquiring may comprise at least one of the steps of transferring the first, second, and third information from the user equipment to an access node with which the user equipment may establish a successful connection subsequent to the radio link failure and transferring the first, second and third information from the access node with which the user equipment may establish the successful connection to an access node executing the determination of the RLF. In particular, in case of a successful reestablishment of a connection immediately subsequent to the RLF, the access node with which the user equipment may establishes the connection may be an access node involved in the handover. In particular, in case of an unsuccessful establishment of a connection subsequent to the RLF and the user equipment being in an idle state, the access node with which the user equipment may establishes the connection may be an access node involved in the handover or another access node. Thus conventional procedures of an user equipment reconnecting to the access network, particularly when being in a connected state and in an idle state, may be used for reporting a RLF indication to the access node executing the RLF evaluation.

In particular, in case the user equipment does not attempt to establish the connection subsequent to the RLF and the user equipment is being in an idle state for longer time it is advantageous if the first information comprises the time difference between the third time point and the first time point and the time difference between the second time point and the third time point. This case may occur when the user equipment recognizes that the Access Stratum Security is not active immediately subsequent to the RLF for the affected radio connection.

The first, second, and third information may be transferred in one message or in separate subsequent messages.

In particular, if only the second and/or third time point may be transferred, the information about the first time point recorded by the access node executing the determination may be used for the determination of the time difference(s). In particular, if the second time point or the first and second and/or the third time points may be transferred, a determination of the time difference(s) between the first and second and/or third time points and/or between the second and third time points may be executed particularly by the access node executing the determination prior to the actual determination of the RLF.

Next, a further exemplary embodiment of the access node will be explained. However, this embodiment also applies to the above mentioned method and the above mentioned user equipment.

The access node may be an eNodeB of a LTE access network, a base transceiver station (BTS) of a GERAN access network or a NodeB an UTRAN access network.

The source access node, the target access node, the access node with which the user equipment may communicate for establishing a connection subsequent to the RLF, the access node with which the user equipment may establish a successful connection after having been in the idle state and the access node executing the determination of the RLF may be of the same access network or may (each) be of (each) different access networks. In particular, few access nodes mentioned above may be of one access network and few access nodes mentioned above may be of a different access network. In particular, the access networks may be based on different access radio technologies (RAT).

In particular, transferring the first and/or second and/or third information may be executed directly between respective communication partners or indirectly via further communication partners. In particular, directly transferring the first and/or second and/or third information may be executed without involvement of the core network for routing and/or relaying purposes, particularly without nodes of the core network such as a Mobility Management Switching Server or a Mobility Management Entity. In particular, an interface comparable to the X2 interface may be usable for a direct transfer of information. In particular, indirectly transferring may comprise a transfer of information along a communication path between communication partners using further nodes of e.g. the core network, particularly by means of appropriate information transfer procedures between the core network and the involved access nodes or by means of using new information elements such as transparent containers included in messages or by using a radio access network (RAN) Information Management framework (RIM), as may be known in connection with SON.

Next, a further exemplary embodiment of the user equipment will be explained. However, this embodiment also applies to the above mentioned method and the above mentioned access node.

The recording unit may be adapted for recording the first and/or second and/or third time point.

The user equipment, particularly the recording unit of the user equipment, may be adapted for recording the second information and/or the third information.

With respect to the access node and the user equipment as described above, the respective units may be implemented in a computer program respectively software on a microprocessor. However, the respective units may also be realized by means of one or more specific electronic circuits respectively hardware. Further, the respective units may also be realized in a hybrid form, i.e. in a combination of software modules and hardware modules.

According to another exemplary embodiment of the invention, a program element is provided. The program element, when being executed by a processor, is adapted to carry out and/or control a method as mentioned above. The program element may be implemented as computer readable instruction code in any suitable programming language, such as, for example, JAVA, C++, and may be stored on a computer-readable medium (removable disk, volatile or non-volatile memory, embedded memory/processor, etc.). The instruction code may be operable to program a computer or any other programmable device to carry out the intended functions. The program element may be available from a network, such as the World Wide Web, from which it may be downloaded.

According to another exemplary embodiment of the invention, a computer-readable medium may be provided. In the computer-readable medium a computer program may be stored. The computer program may be adapted, when being executed by a processor, to carry out and/or control a method as mentioned above. In particular, the computer-readable medium may be a permanent or a rewritable memory within a respective device or located externally. A program element of a computer program may be also transferred to a respective device for example via a cable or a wireless link as a sequence of signals. The computer-readable medium may be readable by a computer or a processor. The computer-readable medium may be, for example but not limited to, an electric, magnetic, optical, infrared or semiconductor system, device or transmission medium. The computer-readable medium may include at least one of the following media: a computer-distributable medium, a program storage medium, a record medium, a computer-readable memory, a random access memory, an erasable programmable read-only memory, a computer-readable software distribution package, a computer-readable signal, a computer-readable telecommunications signal, computer-readable printed matter, and a computer-readable compressed software package.

In particular, data processing which may be performed according to exemplary embodiments of the invention may be realized by a computer program or a program element, that is by software, or by using one or more special electronic optimization circuits, that is in hardware, or in a hybrid form, that is by means of software components and hardware components.

The aspects defined above and further aspects of the present invention are apparent from the examples of embodiment to be described hereinafter and are explained with reference to these examples of embodiment. The invention will be described in more detail hereinafter with reference to examples of embodiment but to which the invention is not limited.

### BRIEF DESCRIPTION OF THE DRAWING

FIG. 1 illustrates a method of determining a “too early handover” radio link failure according to prior art.

FIG. 2 illustrates a method of determining a “too early handover” radio link failure according to an exemplary embodiment of the invention.

FIG. 3 illustrates another method of determining a “too early handover” radio link failure according to an exemplary embodiment of the invention.

FIG. 4 illustrates another method of determining a “too early handover” radio link failure according to an exemplary embodiment of the invention.

FIG. 5 illustrates another method of determining a “handover to wrong cell” radio link failure according to an exemplary embodiment of the invention.

FIG. 6 illustrates a target access node for determining a “too early handover” radio link failure according to an exemplary embodiment of the invention.

FIG. 7 illustrates a user equipment according to an exemplary embodiment of the invention.

FIG. 8 illustrates another method of determining the failure in particular for the case that the user equipment does not immediately subsequent to the RLF attempt to establish the connection, e.g. when Access Stratum Security was not provided.

### DETAILED DESCRIPTION

The illustration in the drawings is schematic. It is noted that in different figures, similar or identical elements are provided with the same reference signs.

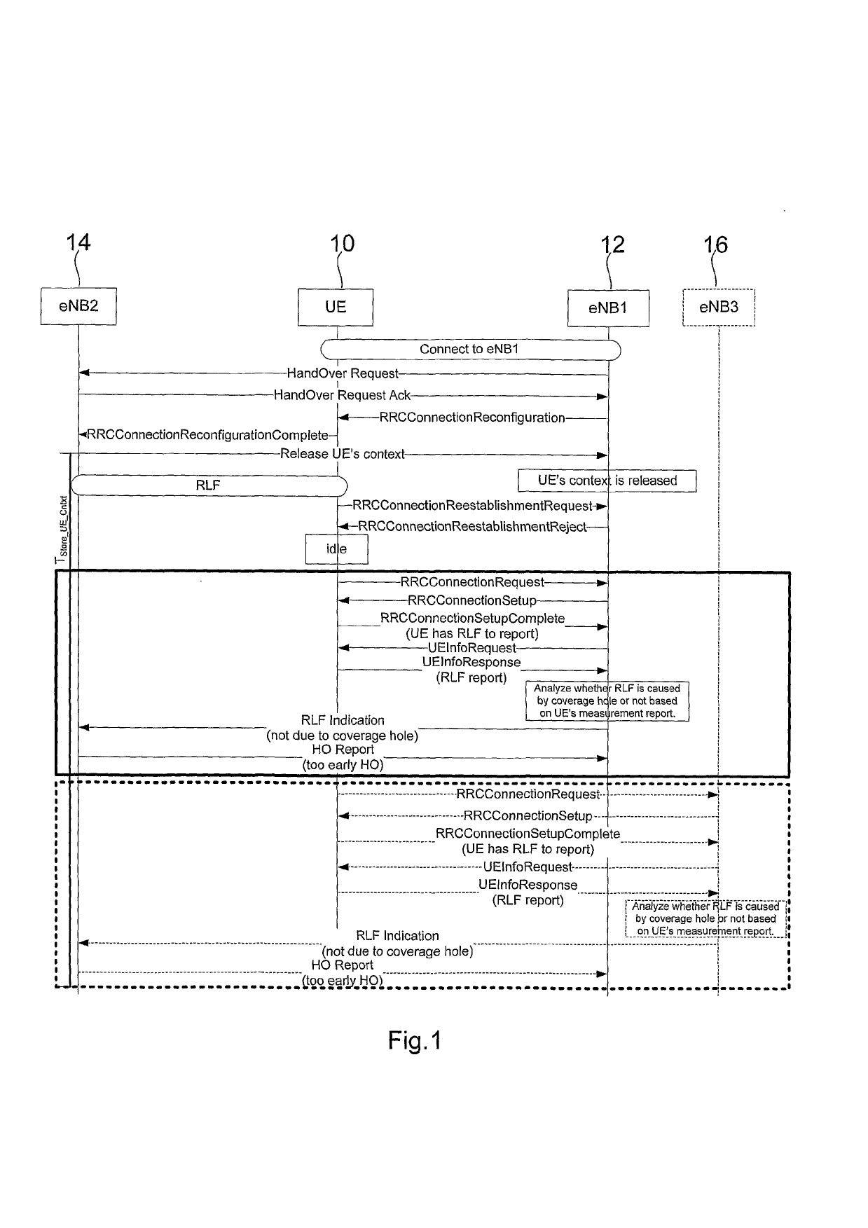

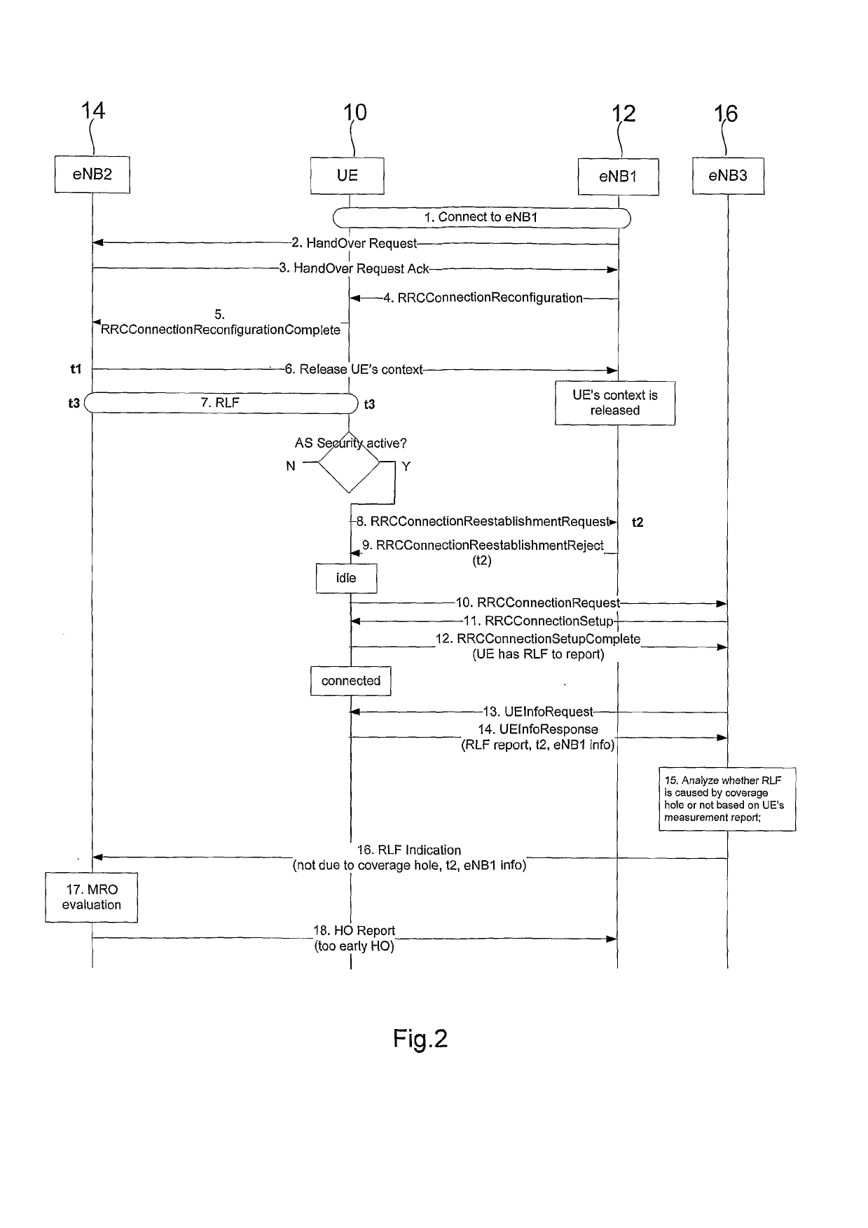

In the following, methods of determining a RLF based on absolute time information and relative time information will be explained. For explanation purposes, it will be assumed that a too early handover RLF has occurred subsequent to a handover from a user equipment from a source access node to a target access node. However, the described analysis of the kind of RLF will also apply to other kind of radio link failures such as a too late handover or a handover to a wrong cell. The communications architecture shown in FIG. 2, 3 are similar to the communications architecture shown in FIG. 1.

Referring to FIG. 2, a user equipment 10 is initially attached to a source access node 12 as indicated by step 1. Handover negotiations between the user equipment 10, the source access node 12 and the target access node 14 are depicted by steps 2-6. Contrary to FIG. 1, when sending a notification to the source access node 12 about releasing a user equipment context (step 6), the target access node 14 records this particular time point t1.

Subsequent to the completed handover, a RLF occurs, as indicated by step 7. As an AS security function of the user equipment is active at the point when the RLF is detected by the user equipment, the user equipment 10 attempts to initiate a connection to the source access node 12 using the RCC Connection Reestablishment procedure, which rejects the request from the user equipment 10 (steps 8, 9). The source access node 12 includes in the return message information about a time point t2 which the source access node 12 has recorded upon receiving the request for reestablishing the connection from the user equipment 10. As the attempt to connect to the source access node 12 has failed, the user equipment 10 goes into an idle state.

When trying to enter a connected state again by connecting anew to the access network via the access node 16, the user equipment 10 requests a connection setup from the access node 16 which in turn acknowledges the setup request (steps 10, 11). Further, the user equipment 10 sends a message to the access node 16 indicating that a RLF has to be reported, as depicted by step 12. The user equipment 10 is then in a connected state again.

Upon being requested by the access node 16, the user equipment 10 sends a message comprising the RLF report, the information about the time point t2, and information called “eNB1 info” about the access node 12 with which the user equipment has communicated for re-establishing the connection subsequent to the RLF (step 14). The information eNB1 info comprises a Physical Cell Identifier (PCI) of the access node 12. After analyzing that the RLF has occurred not due a coverage hole, the access node 16 sends a RLF indication message to the target access node 14 which comprises the information about the performed analysis, the information about the time point t2 and the information eNB1 info.

As indicated by step 17, the target access node 14 performs an evaluation of the RLF by executing a mobility robustness optimization MRO evaluation based on the received information.

First, the target access node 14 determines whether the context of the user equipment 10 is still available in the access node 14. In case the context is not available, the target access node 14 discards the received RLF indication. Otherwise the target access node 14 will proceed as described below, as is the case in this present embodiment.

Next, the target access node 14 determines whether t1 is defined in that the 14 determines whether t1 has been recorded upon accomplishing the handover. As the handover has been completed, the time point t1 is recorded by the target access node 14. The evaluation of the RLF will be further the evaluation based on t1.

Next, the target access node 14 determines the time difference t2−t1 between the time points t2, t1. Then the target access node 14 determines whether the time difference t2−t1 is smaller than a predetermined time threshold T stored within the target access node 14. If t2−t1 is smaller than T, the target access node 14 rules out that the RLF occurred due to a too late handover but evaluates that either a RLF due to a too early handover and a handover to a wrong cell has occurred.

Next, the target access node 14 uses the second information eNB1 info, in order to differ between the RLFs due to a too early handover and a handover to a wrong cell or a RLF related to camping in wrong cell in that the target access node 14 evaluates whether the access node indicated by the second information eNB1 info is the source access node 12 of the last performed handover to which the user equipment 10 has initially been attached. As the access node 12 indicated by the second information eNB1 info is equal to the source access node 12, the determination results in a too early handover. The following table summarized the used MRO determination rules.

| | | Access node indicated | Access node indicated |
|---|---|---|---|
| | | by second information | by second information |
| | | is source access node | is not source access |
| | | 12 | node 12 |
| t1 not | | Too late handover | Too late handover |
| defined | | | |
| t1 | t2-t1 > T | Too late handover | Too late handover |
| defined | | | |
| | t2-t1 < T | Too early handover | Handover to wrong cell |
| | | | or camping in wrong |
| | | | cell |

Thereupon, the target access node 14 is adapted to adjust network parameters stored within the target access node 14 and is adapted to send a handover report about the kind of RLF to the source access node 12, such that the source access node 12 is adapted for adjusting handover parameters stored within the source access node 12 (step 18).

Alternatively, the source access node 12 may record a time point t1 when receiving the notification message in step 6. Then the source access node 12 may include the information on the time points t1, t2 in the ReestablishmentRejectionConnection indication (step 9) and the RLF report message (step 14) and the RLF indication message (step 16) may comprise the information about the time points t1, t2.

Alternatively, the user equipment 10 may be adapted for recording the time point t1 and/or the time point t2 and may include information relating to at least one of these two time points t1, t2 in the RLF report message (step 14). The RLF indication sent from the access node 16 to the target access node 14 may comprise the respective information (step 16).

It may be also possible that either determining whether t1 is defined or comparing the time difference t2−t1 with the threshold may be executed.

Alternatively or in addition, the sequence of the steps described above may be altered.

When sending information about the absolute time points t1, t2, a Radio Resource Control (RCC) protocol and respective X2, S1 interfaces of the LTE access network may be accordingly enhanced, to offer information transfer possibilities.

In case of a too late handover the indication depicted in step 6 of FIG. 2 will never be sent. Accordingly, the first time point is not recorded by the (source) access node 14 such that analysis of the RLF results in a too late handover failure.

Further, in case of a too late handover and the time point t1 being recorded by the user equipment 10 and not by the access node 14, evaluation whether t1 is defined or not corresponds to determining by the access node 14 whether t1 is comprised in the indication sent in step 16. If the time point t1 is not included in the respective indication, a too late handover RLF will be determined.

Further, in case the user equipment 10 may perform a handover to a target access node 14 and may remain connected to the target access node 14 for a particular time span, e.g. one day, and a RLF may occur between the user equipment 10 and the target access node 14, the time point t1 may exit. Thus, by using the condition t2−t1<T it may be judged which kind of RLF may have occurred.

Further, instead of the time point t2 the time point t3 indicating the occurrence of the RLF may be used for determining the RLF. The time point t3 may be recorded by the user equipment upon detecting the RLF as indicated in step 7. The time point t3 may be then transferred to the access node 16 which in turn provides the time point t3 to the target access node 14 (steps 14 and 16).

Alternatively, the time point t3 may be recorded by the target access node 16 upon detecting the RLF (step 7). Then, only the second information eNB1 is transferred to the target access node 14 via the access node 16.

Determination of the RLF based on the time points t1 and t3 and the second information may be identical to the evaluation depicted in the table provided above with exchanging t2 by t3.

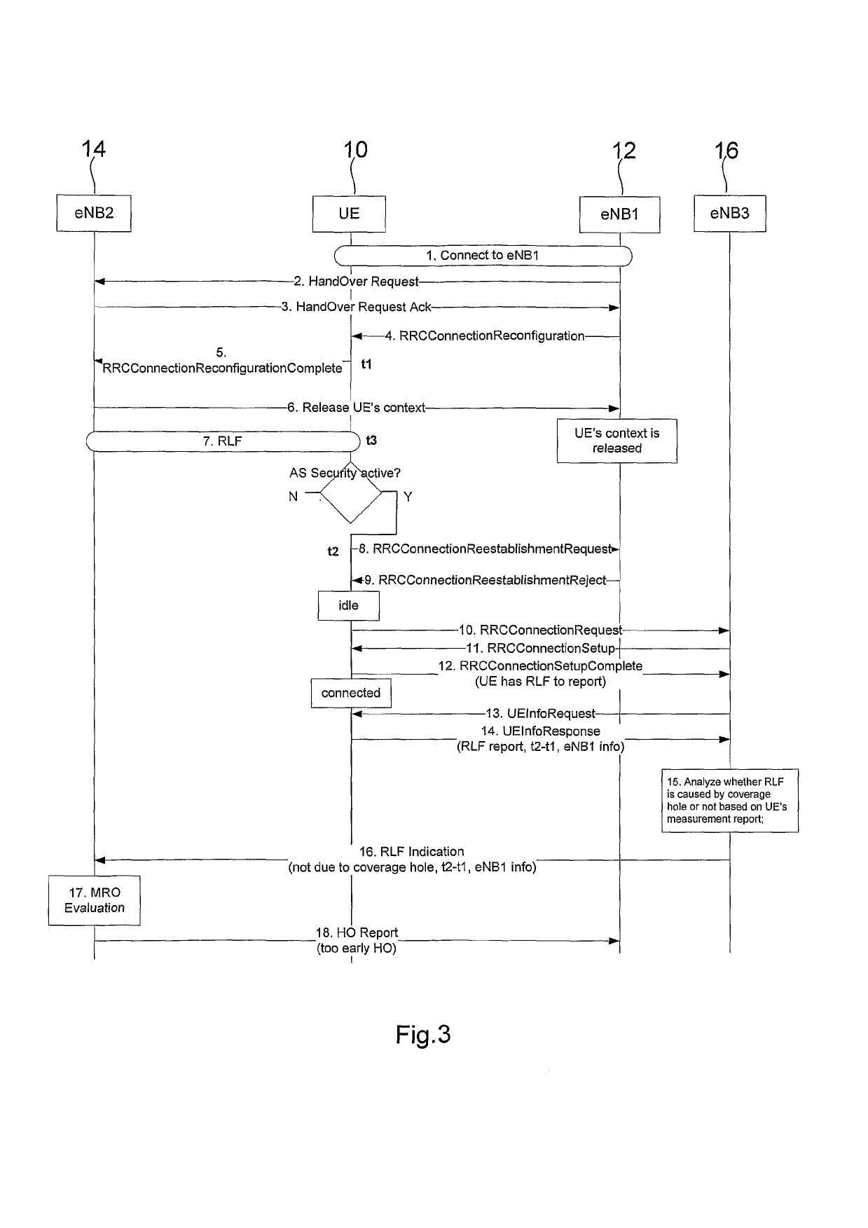

Referring to FIG. 3, a determination of the RLF is based on relative time information being transferred between the respective communications partners.

The user equipment 10 records a time point t1 when sending a handover accomplishment message, in the shown embodiment a RRCConnectionReconfigurationComplete message, to the target access node 14 (step 5). As the AS security function of the user equipment 10 is active, the user equipment 10 remains in a connected state and initiates a connection set up to the source access node 12. Further, the user equipment 10 records a time point t2 when initiating the connection set up to the source access node 12 subsequent to the occurrence of the handover failure (step 8). Further, the user equipment 10 evaluates a time difference t2−t1 between the time points t1, t2 and sends respective information to the access node 16 when reconnecting to the access network (step 14). Accordingly, the RLF indication transmitted between the access node 16 and the target access node 14 comprises the first information about the time difference t2−t1.

Using the above-described determination logic, the target access node 14 determines that the RLF relates to a too early handover failure.

Alternatively, the time point t2 may be recorded by the user equipment 10 upon being notified on the rejection of the connection re-establishment, as indicated by step 9.

Alternatively, the user equipment 10 may calculate the time difference t1−t2, such that the above described determination rules may apply the condition t1−t2>−T for ruling out a too late handover.

Further, the sequence of the above described determination steps may be altered.

Using the time difference t1−t2, t2−t1 instead of the absolute time t2 and/or t1 allows for efficient usage of network resources upon communicating the respective information.

In case of a too late handover the time point t1 can be recorded and thus determined, since the user equipment 10 may have managed to send the Handover Complete indication as depicted in step 5 of FIG. 3, however the access node 14 was not prepared for a handover such that the access node 14 will not receive this indication. The time point t1 may however be not reliable, since if either one of the indications depicted in steps 2-4 may not be received by the corresponding respective sink due to the too late handover failure then the time point t1 may not be determined or recorded. Determining whether the time point t1 is defined relates to determine whether the time difference t2−t1 is included in the RLF indication sent in step 16. If the time difference t2−t1 is not included, determination results in a too late handover. If the time difference t2−t1 is included, the determination based on the time difference t2−t1 and on the eNB1 info will be executed.

Further, instead of the time difference t2−t1 the time difference t3−t1 may be used for evaluating the RLF. The time point t3 may be recorded by the user equipment 10 upon detecting the RLF (step 7).

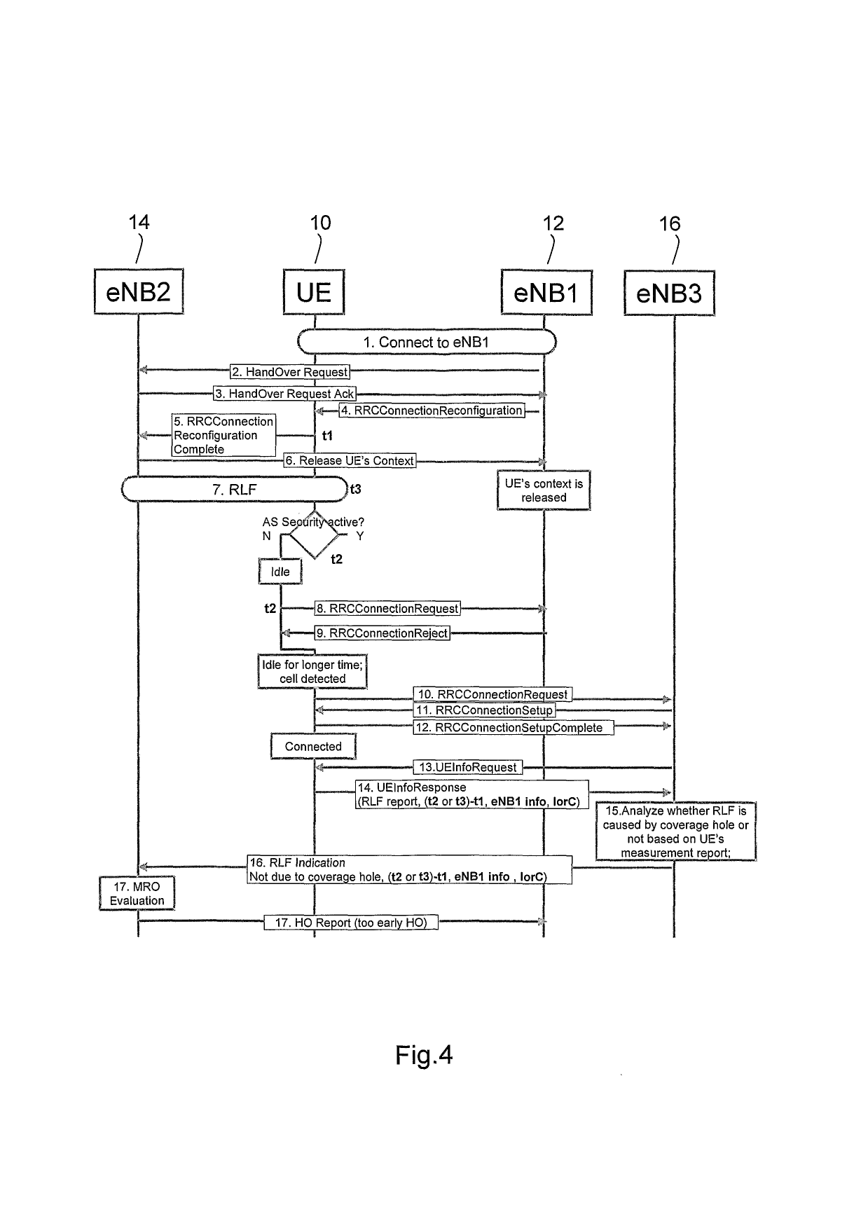

Referring to FIG. 4, a determination of the RLF is based on relative time information being transferred between the respective communications partners.

In the shown embodiment, the AS security function of the user equipment 10 is not active, thus the user equipment 10 enters an idle state for a short time. Thereafter, the user equipment 10 unsuccessfully initiates a connection set up to the source access node 12, enters again an idle state for a longer time and then establishes a new connection to the access node 16 (steps 8 to 12).

When transferring the RLF report to the access node 16, the user equipment further includes third information IorC into the respective message indicating a state from which the user equipment 10 communicates for establishing a connection to an access node 14 prior to the radio link failure. The third information has been recorded by the user equipment at the time point t3.

Respective information is transferred from the access node 16 to the target access node 14.

The determination based on the first and second information is identical as described with respect to the above given table and results in a too early handover.

In case of a handover to a wrong cell, the determination of the RLF is based on the first, second, and third information. The determination based on the first and second information is identical as described with respect to the above given table. Determination of the RLF based on the third information IorC is then subsequently executed, in order to further differ between a handover to a wrong cell and a RLF relating to camping in wrong cell.

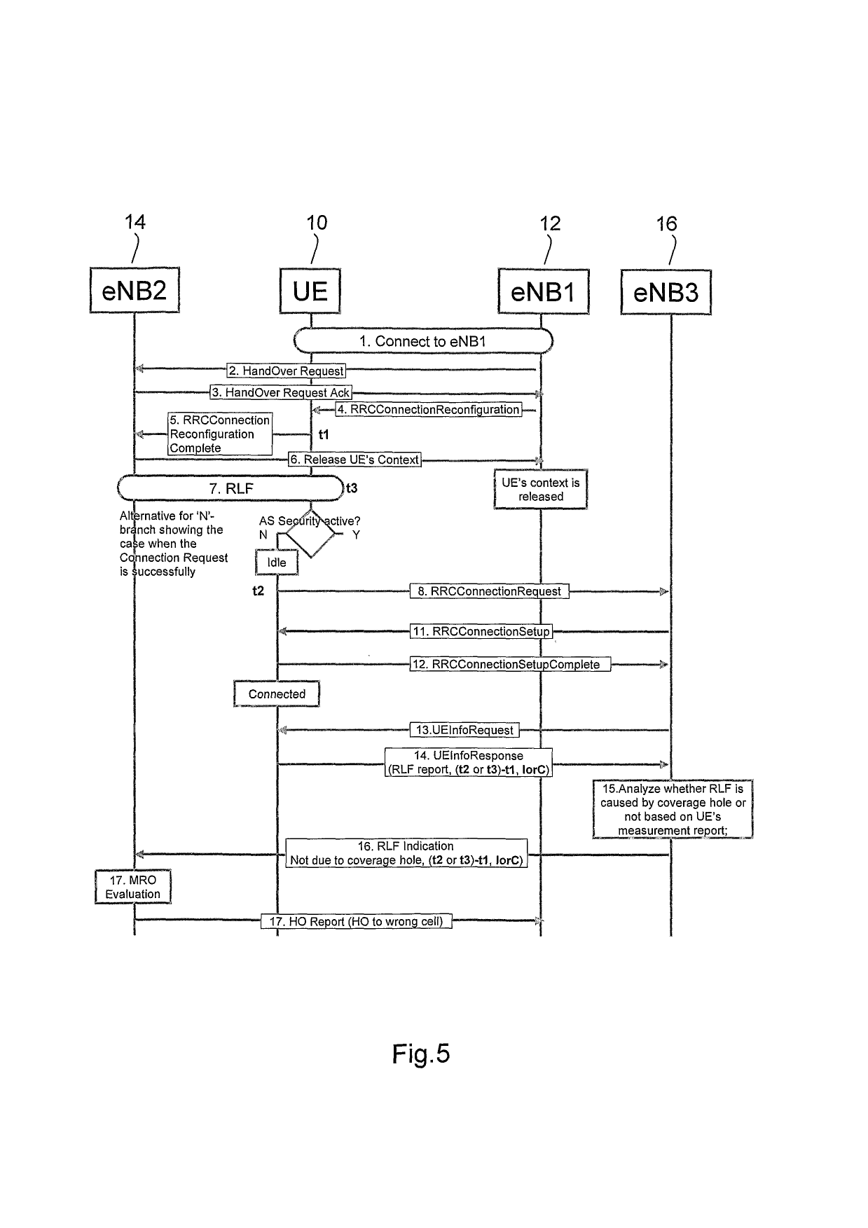

Referring to FIG. 5, another determination of the RLF is based on relative time information being transferred between the respective communications partners.

In the shown embodiment, the AS security function of the user equipment 10 is not active, thus the user equipment enters an idle state for a short time. Thereafter, the user equipment 10 successfully initiates a connection set up to the access node 16 and enters a connected state (steps 8 to 12).

As the connection set up has been successfully performed, the user equipment does not include respective information eNB3 into the UEInfoResponse message (step 14). The target access node 16 derives the second information from the RLF indication in that the target access node 16 determines from which access node 16 the RLF indication comprising the first information has been sent.

Determination of the RLF is executing using the first, second, and third information. In particular, the target access node 16 determines whether the RLF indication has been sent from the source access node 12. As the RLF indication has been sent from the access node 16, evaluation of the RLF results in a handover to a wrong cell or a camping in wrong ell. Thereafter the target access node 16 determines whether the user equipment 16 has been in a connected state prior to the RLF using the third information. As this has been the case, the determined RLF is a handover to wrong cell.

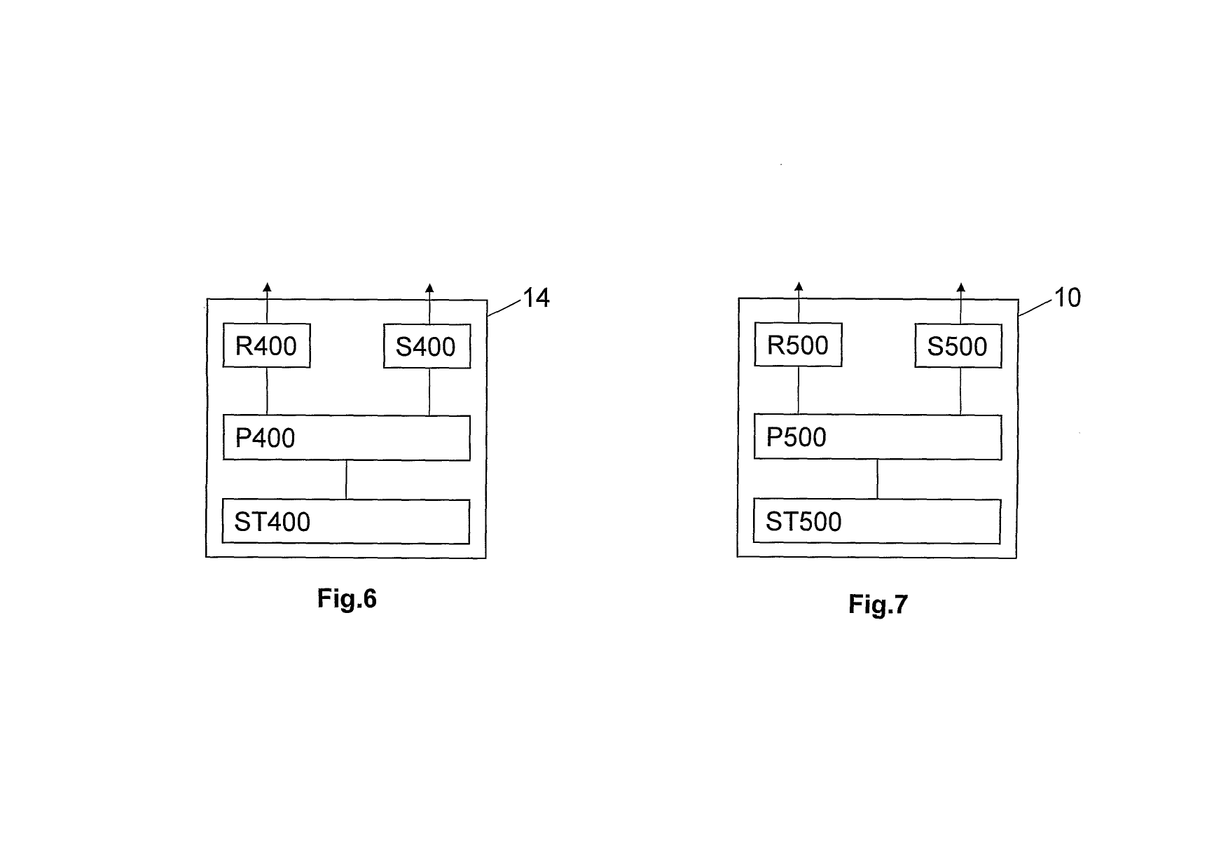

Referring to FIG. 6, an exemplary embodiment of an access node executing the above described methods will be explained in more detail. The access node is adapted as a target access node 14 involved in a handover of a user equipment 10 from a source access node 12 to the target access node 14. However, the access node 14 may be adapted as a source access node in case of a too late handover.

The target access node 14 comprises an acquiring unit, particularly a receiving unit R400 adapted for receiving first information about a time associated with a handover, particularly with the user equipment 10 communicating with an access node 12, 14 for establishing a connection associated with the handover and second information indicating an access node 12 with which the user equipment 10 communicates for establishing a connection subsequent to the radio link failure. The first information may comprise at least one of the first time point t1, the second time point t2, the third time point t3 or at least one of the time difference t2−t1, t1−t2 or t1−t3, t3−t1. The acquiring unit R400 is also adapted for acquiring a third information IorC indicating a state from which the user equipment 10 communicates for establishing a connection to an access node 14 prior to the radio link failure. Further, the target access node 14 comprises a determining unit, particularly a processing unit P400 which is adapted for determining (the reason of) the RLF based on the received first and/or second and optionally third information using the above described determination rules. In particular, the processing unit P400 is adapted for determining whether a time point t1 is defined. Further, the processing unit P400 is adapted for determining a time difference t1−t2, t2−t1, t1−t3, t3−t1 between the first and second or third time points t1, t2, t3. In particular, a separate recording unit may be provided for recording the first time point t1 and the third time point t3. The target access node 14 also comprises a sending unit S400 which is adapted for sending information about the determined RLF to the further access nodes 12, 16. A storage unit ST400 of the target access node 14 is adapted for storing information usable during a method of determining a RLF associated with a handover of a user equipment 10 from the source access node eNB1 to the target access node 14.

Referring to FIG. 7, an exemplary embodiment of a user equipment 10 will be explained in more detail. The user equipment 10 comprises a receiving unit R500 which is adapted for receiving information, a sending unit S500 adapted for sending first, second and optionally third information to further access nodes 12, 14, 16. Such first information relate to a time point t1, t2, t3, time points t1 and t2 t1 and t3, t2 and t3, or time differences t1−t2, t2−t1, t1−t3, t3−t1 associated with the handover and second information indicating the access node 12, 14, 16 with which the user equipment 10 communicates for establishing the connection subsequent to the radio link failure, respectively.

Further, the user equipment 10 comprises a processing unit P500 adapted for processing data usable during a method of determining a RLF of a handover of the user equipment 10 from a source access node 12 to a target access node 14. In particular, the processing unit P500 is adapted for recording the first time point t1 and/or the second time point t2 and/or the third time point t3 and is adapted for determining a time difference t1−t2, t2−t1 between the first and second time points t1, t2 and a time difference t1−t3, t3−t1 between the first and third time points t1, t3. Further, the recording unit P500 is adapted for recording the second information eNB1 and/or the third information IorC. Separate recording units may be provided which may be adapted for recording at least one of the first time point t2, the second time point t1, the second information and the third information. Further, the user equipment 10 comprises a storage unit ST500 being adapted for storing information usable during the above-described method.

It should be noted that the term “comprising” does not exclude other elements or steps and the use of articles “a” or “an” does not exclude a plurality. Also elements described in association with different embodiments may be combined. It should also be noted that reference signs in the claims should not be construed as limiting the scope of the claims.

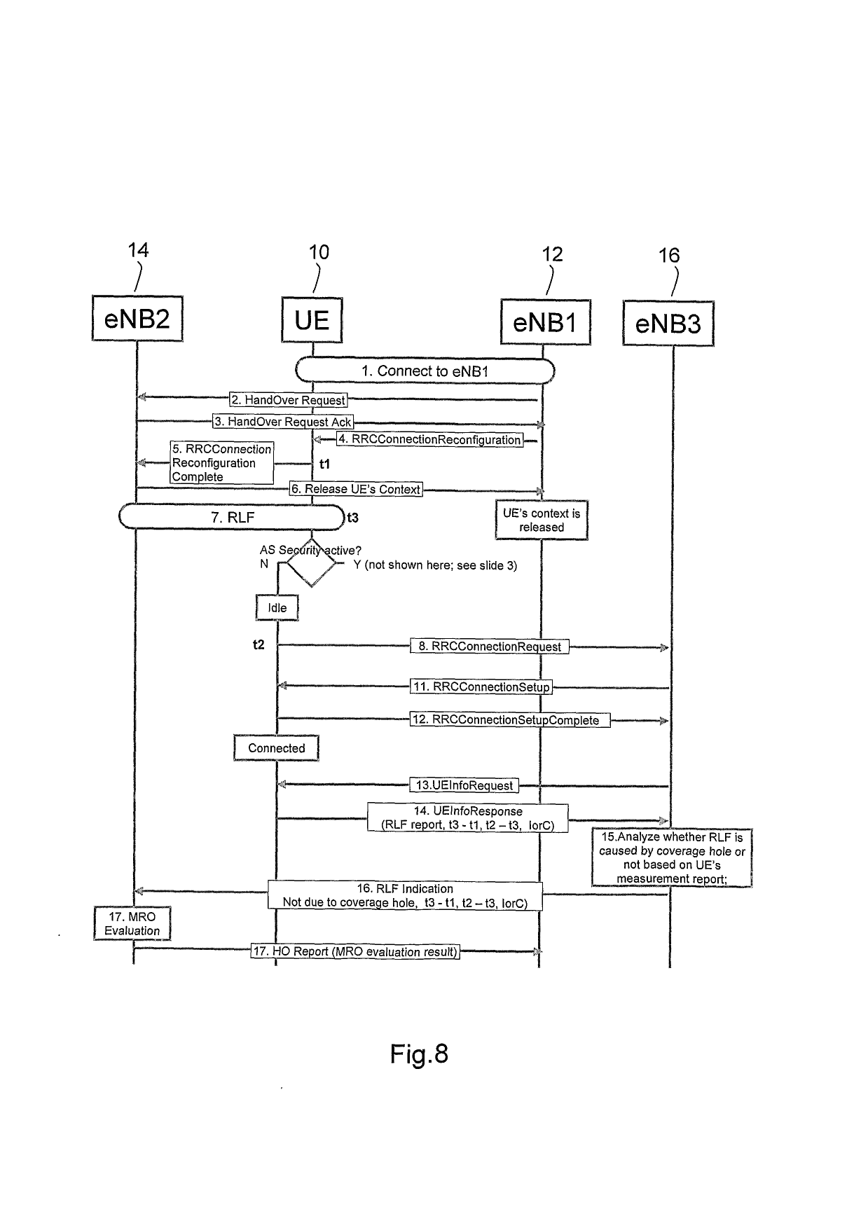

Referring to FIG. 8, a further exemplary embodiment of the method according to FIG. 5 is provided. The method to evaluate the root cause of MRO, according to FIG. 5, is based on the assumption that the user equipment enters an idle state for a short time. But generally it is hard to predict the user equipment's behaviour after it enters the IDLE state. It may also be possible that the user equipment attempts to establish a new connection after a relative long period of time. This, according to the method referring to FIG. 5 increases the time difference between the second time point and the first time point t2−t1, t1−t2. As a result the determining unit P400 of access node 14 may determine a wrong result.

In particular when the time difference between the second time point and the first time point t2−t1, t1−t2 is used by the determining unit P400 the decision Too Late HO will be wrong, because the significant part of the time difference is contributed by the time difference between the second time point and the third time point t2−t3, t3−t2. However, this time difference was assumed to be short according to the method referred to by FIG. 5 and therefore the method according to FIG. 5 fails in this case.

In particular when the time difference between the third time point and the first time point t3−t1, t1−t3 is used by the determining unit P400 will provide a correct decision between Too Late HO and Too Early HO as well as a correct decision between Too Late HO and HO to wrong cell. However the determining unit P400 may provide a wrong decision concerning the differentiation between Too Early HO and HO to wrong cell. The reason is that for this decision the second information is essential. However, in this particular case the user equipment may try the first attempt to establish a new connection to an access node that is irrespectively for providing a correct MRO decision.

Therefore, according to the current embodiment of the invention presented in FIG. 8 the first information comprises two time differences:

The time difference between the third time point and the first time point t3−t1, t1−t3;

and the time difference between the second time point and the third time point t2−t3, t3−t2.

The determining unit P400 of access node 14 uses the first information in the following way in order to allow for correct decisions in this particular case:

Step 1:
(t3−t1 or t1−t3)>Threshold1: Too Late HO
(t3−t1 or t1−t3)<Threshold1: Too Early HO or HO to Wrong Cell

If the processing of Step 1 didn't determine a Too Late HO then Step 2 must be processed in order to determine between Too Early HO or HO to Wrong cell or in order to terminate MRO evaluation without providing a result.

Step 2:
(t2−t3 or t3−t2)<Threshold 2 and the message RLF Indication has been received from access node 12: Too Early HO
(t2−t3 or t3−t2)<Threshold2 and the message RLF Indication has been received from access node 16: HO to Wrong Cell
(t2−t3 or t3−t2)_>Threshold2: This indicates an invalid MRO scenario. The determining unit P400 terminates MRO root cause evaluation without doing a MRO decision and without sending the message HO Report.

Similar to (t3−t1) and (t2−t3), time interval (t3−t1) and (t2−t1) may also be used in a further exemplary embodiment in order to evaluate the root cause of MRO.

1. A method of determining a radio link failure associated with a handover of a user equipment from a source access node to a target access node, wherein the method comprises
acquiring a first information about a time associated with the handover and a second information indicating an access node with which the user equipment communicates for establishing a connection subsequent to the radio link failure, and
determining the radio link failure based on the acquired first and/or second information.

2. The method according to claim 1, further comprising adapting network parameters based on the determined radio link failure.

3. The method according to claim 1, wherein the first information comprises at least one of a first time point associated with an accomplishment of the handover, a second time point associated with the user equipment communicating with the access node for establishing a connection subsequent to the radio link failure, and a third time point associated with an occurrence of the radio link failure.

4. The method according to claim 1, wherein the first information comprises at least one of a time difference between a first time point associated with an accomplishment of the handover and a second time point associated with the user equipment communicating with an access node for establishing a connection subsequent to the radio link failure and a time difference between the first time point associated with an accomplishment of the handover and a third time point associated with an occurrence of the radio link failure and a time difference between the second time point associated with the user equipment communicating with an access node for establishing a connection subsequent to the radio link failure and the third time point associated with an occurrence of the radio link failure.

5. The method according to claims 3, wherein acquiring comprises determining whether the first time point is defined.

6. The method according to claim 3, wherein the first time point is associated with the user equipment indicating to the target access node the accomplishment of the handover or with the target access node indicating to the source access node the accomplishment of the handover.

7. The method according to claim 3, wherein acquiring comprises
recording at least one of the first time point, the second time point and the third time point by the user equipment or by an access node executing the determination of the radio link failure.

8. The method according to claim 3, wherein acquiring comprises
recording the second time point by the user equipment or by the access node with which the user equipment communicates for establishing a connection subsequent to the radio link failure.

9. The method according to claim 1, wherein determining the radio link failure comprises comparing the first information with a predetermined time corresponding to a maximum time difference between a time point associated with the accomplishment of the handover and a time point associated with the user equipment communicating with the access node for establishing the connection subsequent to the radio link failure.

10. The method according to claim 1, wherein determining the radio link failure comprises comparing the first information with a predetermined time corresponding to a maximum time difference between a time point associated with the user equipment communicating with the access node for establishing the connection subsequent to the radio link failure and a time point associated with an occurrence of the radio link failure.

11. The method according to claim 1, wherein determining the radio link failure comprises determining whether the access node indicated by the second information is the source access node of the handover.

12. The method according to claim 1, wherein the method comprises acquiring a third information indicating a state from which the user equipment communicates for establishing a connection to an access node prior to the radio link failure, wherein determining the radio link failure is based on the third information, and wherein determining the radio link failure comprises determining whether the state of the user equipment indicated by the third information is a connected state.

13. The method according to claim 1, wherein acquiring comprises at least one of
transferring the first, second, and third information from the user equipment to an access node with which the user equipment establishes a successful connection subsequent to the radio link failure, and
transferring the first, second, and third information from the access node with which the user equipment establishes the successful connection to the access node executing the determination of the radio link failure.

14. An access node for determining a radio link failure associated with a handover of a user equipment from a source access node to a target access node, wherein the access node comprises
an acquiring unit adapted for acquiring a first information about a time associated with the handover and a second information indicating the access node with which the user equipment communicates for establishing a connection subsequent to radio link failure, and
a determining unit adapted for determining the radio link failure based on the acquired first and/or second information.

15. The access node of claim 14, wherein the access node is an eNodeB of a LTE access network, a base transceiver station of a GERAN access network or a NodeB of an UTRAN access network.

16. A user equipment, wherein the user equipment is adapted for performing a handover from a source access node to a target access node, wherein the user equipment comprises
a recording unit adapted for recording a first information about a time associated with the handover, and
a sending unit adapted for sending the first information and a second information indicating an access node with which the user equipment communicates for establishing a connection subsequent to the radio link failure, such that the radio link failure is determinable based on the sent first and/or second information.
